(19) United States
(12) Patent Application Publication
(10) Pub. No.: US 2025/0003771 A1
(43) Pub. Date: Jan. 2, 2025

(54) DETECTION SYSTEM AND MUSICAL INSTRUMENT

(71) Applicant: YAMAHA CORPORATION, Hamamatsu-shi (JP)

(72) Inventors: Akihiko KOMATSU, Hamamatsu-shi (JP); Michiko TANOUE, Hamamatsu-shi (JP)

(21) Appl. No.: 18/742,086

(22) Filed: Jun. 13, 2024

(30) Foreign Application Priority Data
Jun. 28, 2023 (JP) 2023-105829

(51) Int. Cl. G01D 5/20; G10H 1/055; G10H 1/34

(52) U.S. Cl. CPC G01D 5/20; G10H 1/0555; G10H 1/344

(57) ABSTRACT

A first coil includes a first portion and a second portion disposed along a first axis. A second coil includes a third portion facing the first portion and a fourth portion facing the second portion. In the direction of the first axis, a first outer dimension of the first portion is equal to or smaller than a third outer dimension of the third portion, and a second outer dimension of the second portion is equal to or smaller than a fourth outer dimension of the fourth portion. A first distance between the centers of the first portion and the second portion is larger than a second distance between the centers of the third portion and the fourth portion, and the centers of the third portion and the fourth portion are positioned between the centers of the first portion and the second portion in the direction of the first axis.

### CROSS REFERENCE TO RELATED APPLICATION

This application is based on and claims priority from Japanese Patent Application No. 2023-105829, filed on Jun. 28, 2023, the entire contents of which are incorporated herein by reference.

### BACKGROUND

### Technical Field

The present disclosure relates to a technique for detecting displacement by using magnetism.

### Background Information

There have been proposed a variety of techniques for detecting displacement of a movable member, such as a key or a hammer shank, of a keyboard musical instrument. WO 2021/100448, for example, discloses a keyboard musical instrument that generates a detection signal dependent on a distance between a first coil, which is provided in an operative element of a musical instrument, and a second coil that generates a magnetic field.

A problem exists with the prior-art technique, however, in that errors can occur in positions between the first coil and the second coil resulting in degradation of detection accuracy.

### SUMMARY

In view of the circumstances described above, according to one aspect of the present disclosure, a detection signal is generated dependent on a distance between a displaceable first coil and a second coil that generates a magnetic field upon supply of a drive signal, to prevent or reduce degradation in detection accuracy due to errors between positions of the first coil and the second coil.

To address the disadvantages described with respect to the prior art, a detection system according to an aspect of the present disclosure includes a displaceable first coil and a second coil configured to receive a drive signal and to generate a magnetic field based on the received drive signal, the detection system being configured to generate a detection signal dependent on a distance between the displaceable first coil and the second coil, in which the displaceable first coil includes a first portion and a second portion that are disposed along a first axis, the second coil includes a third portion facing the first portion and a fourth portion facing the second portion, a first outer dimension of the first portion in a direction of the first axis is equal to or smaller than a third outer dimension of the third portion in the direction of the first axis, a second outer dimension of the second portion in the direction of the first axis is equal to or smaller than a fourth outer dimension of the fourth portion in the direction of the first axis, a first distance between the center of the first portion and the center of the second portion is larger than a second distance between the center of the third portion and the center of the fourth portion, and the center of the third portion and the center of the fourth portion are positioned between the center of the first portion and the center of the second portion in the direction of the first axis.

A musical instrument according to an aspect of the present disclosure includes a movable member that is displaceable responsive to a playing operation, and a detection system that includes a first coil disposed on the movable member and a second coil configured to receive a drive signal and to generate a magnetic field based on the received drive signal, the detection system is configured to generate a detection signal dependent on a distance between the first coil and the second coil, the first coil includes a first portion and a second portion that are disposed along a first axis, the second coil includes a third portion facing the first portion and a fourth portion facing the second portion, a first outer dimension of the first portion in a direction of the first axis is equal to or smaller than a third outer dimension of the third portion in the direction of the first axis, a second outer dimension of the second portion in the direction of the first axis is equal to or smaller than a fourth outer dimension of the fourth portion in the direction of the first axis, a first distance between the center of the first portion and the center of the second portion is larger than a second distance between the center of the third portion and the center of the fourth portion, and the center of the third portion and the center of the fourth portion are positioned between the center of the first portion and the center of the second portion in the direction of the first axis.

### BRIEF DESCRIPTION OF THE DRAWINGS

FIG. 1 is a block diagram illustrating a configuration of a keyboard musical instrument according to a first embodiment;

FIG. 2 is a side view illustrating a configuration of a musical instrument keyboard unit;

FIG. 3 is a block diagram illustrating a configuration of a detection system and a control system;

FIG. 4 is a circuit diagram of a magnetic sensor;

FIG. 5 is a block diagram illustrating a configuration of a drive circuit;

FIG. 6 is a plan view of a detectable part;

FIG. 7 is a sectional view taken along line VII-VII in FIG. 6;

FIG. 8 is a plan view of a signal generator;

FIG. 9 is a cross-sectional view taken along line IX-IX in FIG. 8;

FIG. 10 is a schematic diagram showing dimensional and positional relations between a movable coil and a detection coil;

FIG. 11 is an explanatory diagram of the advantageous effects of the first embodiment;

FIG. 12 is a graph showing the relation between the center-to-center distance ratio and an amount of speed fluctuation according to a second embodiment;

FIG. 13 is a schematic diagram of the keyboard musical instrument according to a modification;

FIG. 14 is a schematic diagram of a pedal mechanism according to a modification;

FIG. 15 is a schematic diagram showing dimensional and positional relations between the movable coil and the detection coil according to a modification;

FIG. 16 is a schematic diagram showing dimensional and positional relations between the movable coil and the detection coil according to a modification; and

FIG. 17 is a schematic diagram showing dimensional and positional relations between the movable coil and the detection coil according to a modification.

### DETAILED DESCRIPTION

### A: First Embodiment

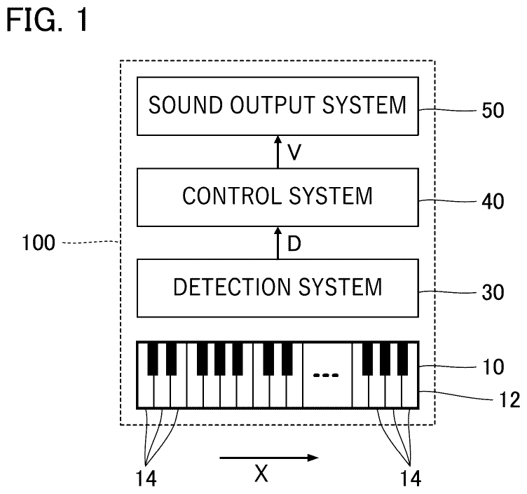

FIG. 1 is a block diagram illustrating a configuration of a keyboard musical instrument 100 according to a first embodiment of the present disclosure. The keyboard musical instrument 100 is an electronic musical instrument (specifically, an electric piano) that includes a keyboard unit 10, a detection system 30, a control system 40, and a sound output system 50.

The keyboard unit 10 includes a keyboard 12. The keyboard 12 has a plurality of keys 14 (white keys and black keys) each of which corresponds to a different pitch. The plurality of keys 14 are aligned along an X-axis in horizontal plane extending laterally relative to the user. Each of the plurality of keys 14 is displaceable responsive to a playing operation by the user (hereinafter, simply referred to as a “user playing operation”). The user playing operation includes depressing and releasing a key, for example. The detection system 30 detects the user playing operation.

The control system 40 generates an audio signal V based on a detection result made by the detection system 30. The audio signal V is a signal indicative of a waveform of a music sound corresponding to the user playing operation. The control system 40 may be configured separately from the keyboard musical instrument 100. For example, the control system 40 may be an information-processing device, such as a smartphone, a tablet terminal, or a personal computer.

The sound output system 50 is configured of one or more loudspeakers, or configured of headphones (earphones) worn by the user, and outputs the music sound indicated by the audio signal V. The sound output system 50 is configured separately from the keyboard musical instrument 100 and connected thereto either by wire or wirelessly.

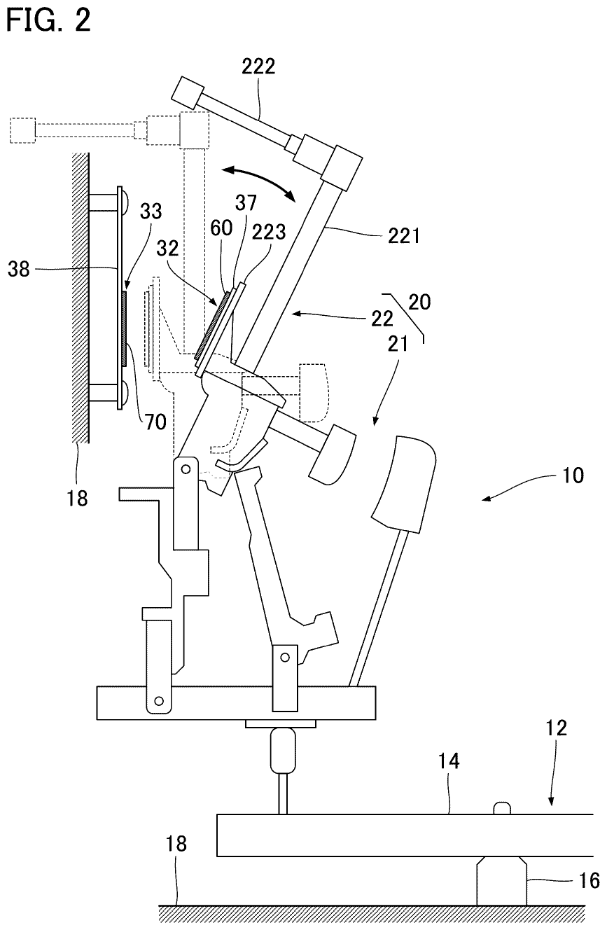

FIG. 2 is a side view illustrating a configuration of the keyboard unit 10. The configuration illustrated in FIG. 2 focusses on one of the plurality of keys 14 of the keyboard 12. Each of the plurality of keys 14 of the keyboard 12 is supported by a support structure 18 via a balance pin 16 that acts as a fulcrum. The support structure 18 supports each element of the keyboard musical instrument 100. An end of one or more of the plurality of keys 14 is vertically displaced responsive to the user playing operation.

In addition to the keyboard 12, the keyboard unit 10 includes a plurality of drive mechanisms 20 each corresponding to respective ones of the plurality of keys 14. Each of the plurality of drive mechanisms 20 is an action mechanism and operates responsive to the user playing operation, and each includes a transmission mechanism 21 and a hammer mechanism 22.

The transmission mechanism 21 transmits to the hammer mechanism 22 displacement of a respective key 14 in concurrence with the user playing operation. Specifically, the transmission mechanism 21 is a mechanical element, such as a whippen or a jack.

The hammer mechanism 22 includes a hammer shank 221, a weight 222, and a holding member 223. The hammer shank 221 is an elongate cylindrical structure. The weight 222 is a counterweight made of a metal and imparts an appropriate weight sense to the user during the user playing operation. The holding member 223 is a structure fixed to the hammer shank 221. The transmission mechanism 21 causes the hammer mechanism 22 to pivot in concurrence with displacement of the respective key 14. In other words, the hammer mechanism 22 is a movable member that is displaceable responsive to the user playing operation.

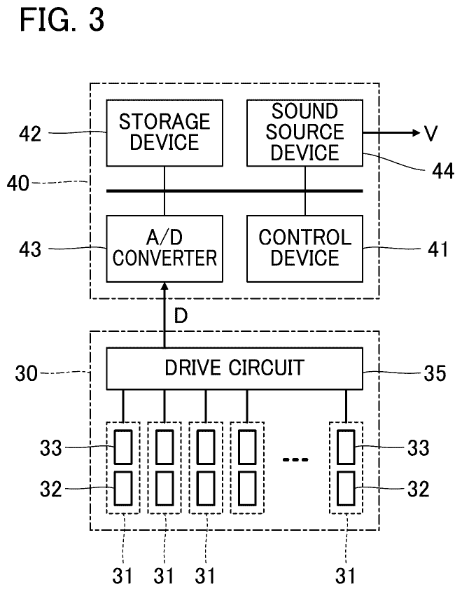

FIG. 3 is a block diagram illustrating a configuration of the detection system 30 and the control system 40. The detection system 30 includes a plurality of magnetic sensors 31, each corresponding to respective ones of the plurality of drive mechanisms 20, and a drive circuit 35 that drives each of the plurality of magnetic sensors 31. The plurality of magnetic sensors 31 corresponding to respective ones of the plurality of drive mechanisms 20, is each a sensor that detects a position of a hammer mechanism 22 each of the drive mechanism 20. The plurality of magnetic sensors 31 each includes a detectable part 32 and a signal generator 33. In other words, for each of the plurality of hammer mechanisms 22 there is provided a pair of the detectable part 32 and the signal generator 33.

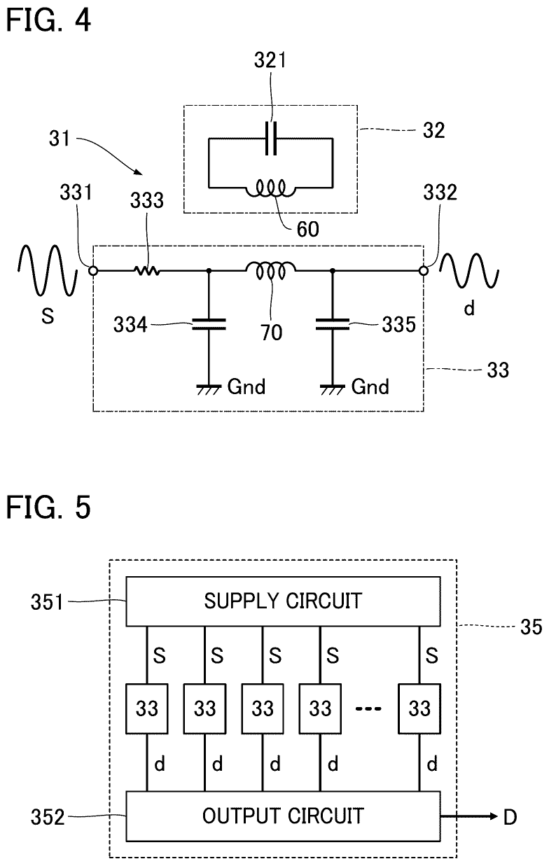

FIG. 4 is a circuit diagram illustrating an electrical configuration of one of the plurality of magnetic sensors 31. The detectable part 32 is a resonance circuit that includes a capacitive element 321 and a movable coil 60. One end of the movable coil 60 and the capacitive element 321 are connected to each other, and the other end of the movable coil 60 and the capacitive element 321 are connected to each other. The movable coil 60 is an example of a “first coil.”

The signal generator 33 is a resonance circuit that includes an input terminal 331, an output terminal 332, a resistive element 333, a detection coil 70, a capacitive element 334, and a capacitive element 335. One end of the resistive element 333 is connected to the input terminal 331, and the other end of the resistive element 333 is connected to one end of the capacitive element 334 and to one end of the detection coil 70. The other end of the detection coil 70 is connected to the output terminal 332 and to one end of the capacitive element 335. The other end of the capacitive element 334 and the other end of the capacitive element 335 are grounded (Gnd). The resonance frequency of the signal generator 33 and the resonance frequency of the detectable part 32 are set to the same frequency. However, the resonance frequency of the signal generator 33 may be set to a frequency different to that of the detectable part 32. The detection coil 70 is an example of a “second coil.”

As illustrated in FIG. 2, each of a plurality of detectable parts 32 is disposed on a movable substrate 37. The movable substrate 37 is a wiring substrate provided separately for each of the plurality of keys 14. Consequently, the plurality of the detectable parts 32 is aligned along the direction of the X-axis. The movable substrate 37 is supported by the holding member 223 described above. The plurality of detectable parts 32 (movable coils 60) is each provided with a respective hammer mechanism 22, and is displaceable responsive to the user playing operation.

In contrast, a plurality of signal generators 33 is disposed on a fixed substrate 38. The fixed substrate 38 is a wiring substrate that extends in the direction of the X-axis over the plurality of keys 14. The plurality of signal generators 33 is aligned along the direction of the X-axis. The fixed substrate 38 is fixed to the support structure 18. Thus, each movable coil 60 is displaceable in concurrence with the user playing operation. Conversely, each detection coil 70 is not displaced in concurrence with the user playing operation.

The movable coil 60 and the detection coil 70 face each other with a space interposed therebetween. As described above, the movable coil 60 is provided within the pivotable hammer mechanism 22, and the detection coil 70 is fixed to the support structure 18. Therefore, a distance between the movable coil 60 and the detection coil 70 varies in concurrence with the user playing operation. The drive circuit 35 shown in FIG. 3 generates a detection signal D dependent on the distance between the movable coil 60 and the detection coil 70.

FIG. 5 is a block diagram illustrating a configuration of the drive circuit 35. The drive circuit 35 includes a supply circuit 351 and an output circuit 352. The supply circuit 351 supplies a drive signal S to an input terminal 331 of each of the plurality of signal generators 33. The supply circuit 351 is, for example, a demultiplexer that supplies the drive signal S each to the plurality of signal generators 33 in a time-division manner. A signal level of the drive signal S varies periodically. The drive signal S is, for example, a periodic signal having a particular waveform, such as a sine wave or a square wave. The frequency of the drive signal S is sufficiently shorter than a time length of the period in which the drive signal S is supplied each to the plurality of signal generators 33. The frequency of the drive signal S is set to a frequency substantially equivalent to the resonance frequency of the pair of the signal generator 33 and the detectable part 32.

The drive signal S is supplied to the detection coil 70 via the input terminal 331 and the resistive element 333. A magnetic field is generated in the detection coil 70 upon the supply of the drive signal S. Electromagnetic induction caused by the magnetic field generated in the detection coil 70 generates an induced current in the movable coil 60 of the detectable part 32. In other words, a magnetic field that cancels a change in the magnetic field of the detection coil 70 is generated in the movable coil 60. The magnetic field generated in the movable coil 60 varies dependent on the distance between the movable coil 60 and the detection coil 70. As a result, a detection signal d, an amplitude of which varies dependent on the distance between the movable coil 60 and the detection coil 70, is output from the output terminal 332 of the signal generator 33. The detection signal d is a periodic signal a level of which varies at a frequency equivalent to that of the drive signal S.

The output circuit 352 shown in FIG. 5 is a multiplexer that generates a detection signal D by arranging the detection signals d sequentially output from the plurality of signal generators 33 on a time axis. In other words, the detection signal D is a periodic signal the amplitude of which varies dependent on the distance between the movable coil 60 and the detection coil 70. As described above, the distance between the movable coil 60 and the detection coil 70 depends on a position of the hammer mechanism 22. Thus, the detection signal D is a signal that corresponds to the position of the hammer mechanism 22.

As described above, the detection system 30 according to the first embodiment generates a detection signal D dependent on a distance between the movable coil 60 and the detection coil 70. The detection signal D generated by the detection system 30 is supplied to the control system 40. The detection signal D generated by the output circuit 352 is subjected to rectification (half-wave or full-wave rectification) and smoothing, and may be supplied to the control system 40.

The control system 40 in FIG. 3 generates an audio signal V corresponding to the detection signal D. The control system 40 is implemented by a computer system including a control device 41, a storage device 42, an A/D converter 43, and a sound source device 44. The control system 40 may be implemented either by a single device or by a plurality of devices configured separately from each other.

The control device 41 is constituted of one or more processors that control each element of the keyboard musical instrument 100. More specifically, the control device 41 is constituted of one or more types of processors, such as a central processing unit (CPU), a sound processing unit (SPU), a digital signal processor (DSP), a field programmable gate array (FPGA), or an application specific integrated circuit (ASIC).

The storage device 42 is constituted of one or more memories that store computer programs executed by the control device 41 and various kinds of data used by the control device 41. The storage device 42 is constituted of a known recording medium, such as a magnetic recording medium or a semiconductor recording medium. The storage device 42 may be constituted of a combination of a plurality of types of recording media. The storage device 42 may be a portable recording medium detachable from the keyboard musical instrument 100, or an external recording medium (e.g., online storage) with which the keyboard musical instrument 100 can communicate.

The A/D converter 43 converts the detection signal D supplied from the detection system 30 from an analog signal to a digital signal. The control device 41 analyzes the converted detection signal D, thereby analyzing a position each of the hammer mechanisms 22.

The sound source device 44 generates an audio signal V indicative of the sound specified by the control device 41. The control device 41 instructs the sound source device 44 to generate a music sound based on the detection signal D. For example, the sound source device 44 is instructed to generate a music sound with acoustic characteristics (such as sound quality or volume) depending on the detection signal D. In this way, an audio signal V indicative of a music sound that accords with the user playing operation is generated. The functions of the sound source device 44 may be implemented by the control device 41 executing a computer program stored in the storage device 42.

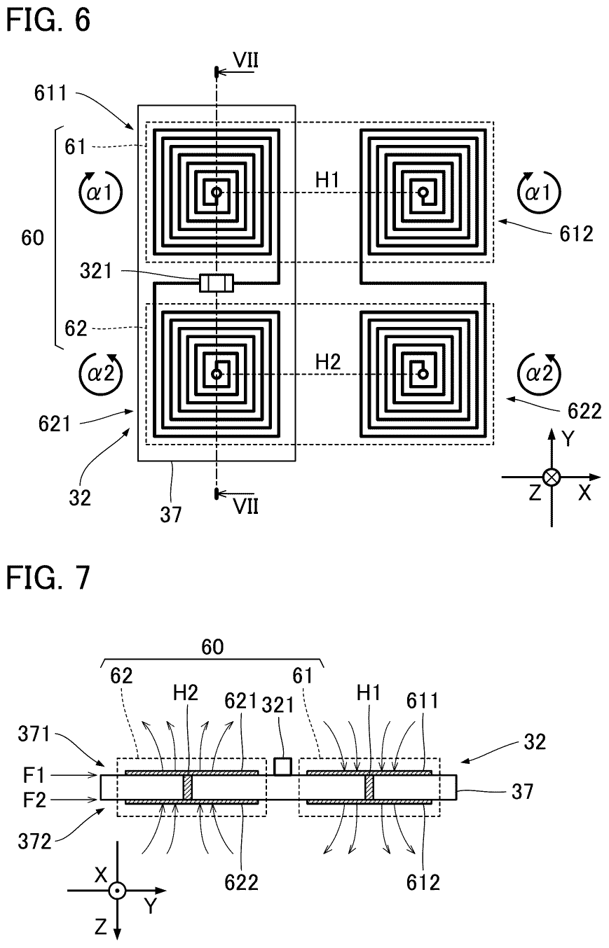

FIG. 6 is a plan view of the detectable part 32. FIG. 7 is a sectional view taken along line VII-VII in FIG. 6. FIGS. 6 and 7 illustrate three axes (X, Y, and Z-axes) that are orthogonal to each another. The X-axis is an axis along the array of the keys 14 (i.e., the horizontal or lateral direction) as described above. The Y-axis is an axis along the longitudinal direction of the hammer mechanism 22. The Z-axis is an axis orthogonal to the X-Y plane. The Y-axis is an example of a “first axis,” and the X-axis is an example of a “second axis.” An object observed with a line of sight along the Z-axis is hereinafter referred to as “plan view.”

As described above, the detectable part 32 is disposed on the movable substrate 37. The movable substrate 37 is a rigid wiring substrate and is made of an insulating material. The movable substrate 37 has a first surface F1 and a second surface F2. The first surface F1 and the second surface F2 oppose each other. The first surface F1 is a surface of the movable substrate 37 facing the signal generator 33, and the second surface F2 is a surface of the movable substrate 37 adjacent to the hammer mechanism 22. The capacitive element 321 is mounted on the first surface F1.

A conductive pattern 371 is formed on the first surface F1; and a conductive pattern 372 is formed on the second surface F2. The conductive pattern 371 and the conductive pattern 372 are formed, for example, by patterning a conductive film to cover the movable substrate 37.

The movable coil 60 includes a first portion 61 and a second portion 62. The first portion 61 and the second portion 62 are aligned along the direction of the Y-axis (i.e., a longitudinal direction of each of the plurality of keys 14). Specifically, the first portion 61 is positioned in the positive direction of the Y-axis with respect to the second portion 62.

The first portion 61 is layered with a winding portion 611 laminated on a winding portion 612. Similarly, the second portion 62 is layered with a winding portion 621 laminated on a winding portion 622. The winding portion 611 and the winding portion 621 are included in the conductive pattern 371 on the first surface F1 and are formed with a spiral shape in a clockwise direction from their inside to their outside in plan view. The winding portion 612 and the winding portion 622 are included in the conductive pattern 372 on the second surface F2 and are formed with a spiral shape in a counterclockwise direction from their inside to their outside in plan view. The capacitive element 321 is disposed between the winding portion 611 and the winding portion 621, and the winding portion 612 and the winding portion 622 are connected to each other on the second surface F2.

The center of the winding portion 611 and the center of the winding portion 612 are electrically connected to each other through a via H1. Similarly, the center of the winding portion 621 and the center of the winding portion 622 are electrically connected to each other through a via H2. The vias H1 and H2 are through holes formed in the movable substrate 37.

As will be apparent from FIG. 6, when a current in a first direction al flows in the winding portion 611, a current in the first direction α1 also flows in the winding portion 612. With a current in the first direction α1 flowing in the winding portion 611, a current in a second direction α2 opposite to the first direction al flows in the winding portions 621 and 622. In other words, when an induced current is generated in the movable coil 60 due to electromagnetic induction of the magnetic field generated in the detection coil 70, magnetic fields in opposite directions are generated in the first portion 61 and the second portion 62, as illustrated in FIG. 7.

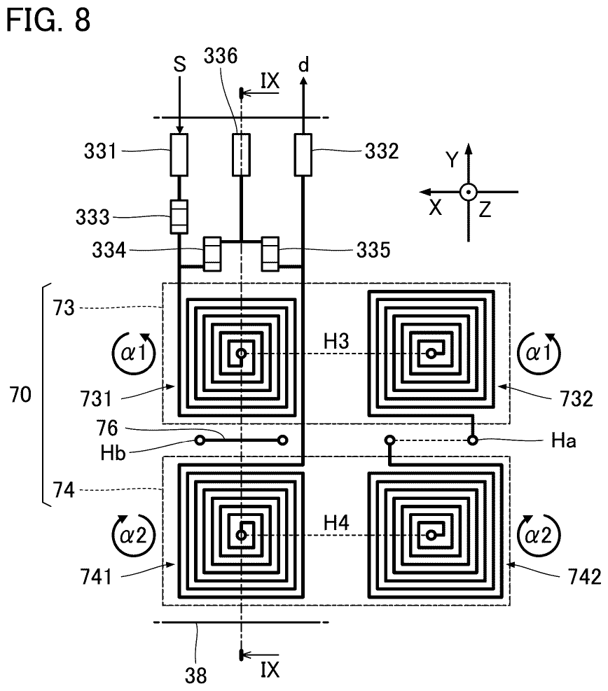

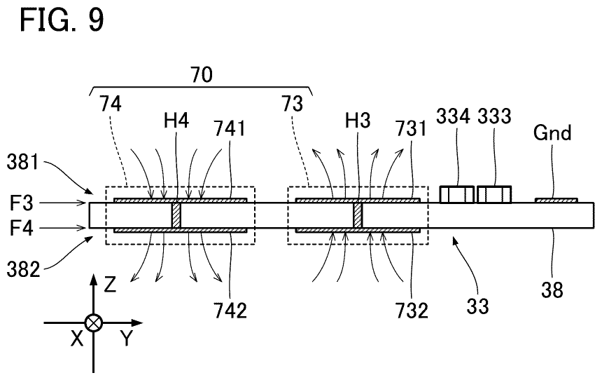

FIG. 8 is a plan view of the signal generator 33. FIG. 9 is a cross-sectional view taken along line IX-IX in FIG. 8. FIGS. 8 and 9 illustrate the three axes (X, Y, and Z-axes) corresponding to the three axes in FIGS. 6 and 7. The angle between the movable substrate 37 and the fixed substrate 38 varies with rotation of the hammer mechanism 22. In the following, for convenience of explanation a case is assumed in which the movable substrate 37 and the fixed substrate 38 are substantially parallel, and the three axes are shared by the movable substrate 37 and the fixed substrate 38.

As described above, the signal generator 33 is disposed on the fixed substrate 38. The fixed substrate 38 has a third surface F3 and a fourth surface F4. The third surface F3 and the fourth surface F4 are positioned opposite to each other. The third surface F3 is a surface of the fixed substrate 38 facing the movable substrate 37. The resistive element 333, the capacitive element 334, and the capacitive element 335 are mounted on the third surface F3 for each of the signal generators 33.

A conductive pattern 381 is formed on the third surface F3 of the fixed substrate 38. The conductive pattern 381 includes the input terminal 331, the output terminal 332, and a ground terminal 336 (Gnd) for each of the signal generators 33. In contrast, a conductive pattern 382 is formed on the fourth surface F4. The conductive pattern 381 and the conductive pattern 382 are formed by patterning a conductive film to cover the fixed substrate 38, for example.

The detection coil 70 includes a third portion 73 and a fourth portion 74. The third portion 73 and the fourth portion 74 are aligned along the direction of the Y-axis (i.e., the longitudinal direction of each key 14). Specifically, the third portion 73 is positioned in the positive direction of the Y-axis with respect to the fourth portion 74. The third portion 73 of the detection coil 70 faces the first portion 61 of the movable coil 60 corresponding to the detection coil 70. In other words, the first portion 61 and the third portion 73 overlap each other when viewed in the direction of the Z-axis. The fourth portion 74 of the detection coil 70 faces the second portion 62 of the movable coil 60 corresponding to the detection coil 70. In other words, the second portion 62 and the fourth portion 74 overlap each other when viewed in the direction of the Z-axis.

The third portion 73 is configured with a winding portion 731 laminated on a winding portion 732; and the fourth portion 74 is configured with a winding portion 741 laminated on a winding portion 742. The winding portion 731 and the winding portion 741 are included in the conductive pattern 381 on the third surface F3 and are formed with a spiral shape in a clockwise direction from the inside to the outside in plan view. The winding portions 732 and 742 are included in the conductive pattern 382 on the fourth surface F4 and are formed with a spiral shape in a counterclockwise direction from the inside to the outside in plan view.

The center of the winding portion 731 and the center of the winding portion 732 are electrically connected to each other through a via H3. Similarly, the center of winding portion 741 and the center of the winding portion 742 are electrically connected to each other through a via H4. The vias H3 and H4 are through holes formed in the fixed substrate 38.

The winding portion 731 is connected to the input terminal 331 via the resistive element 333, and the winding portion 741 is connected to the output terminal 332. The capacitive element 334 is disposed between the resistive element 333 and the ground terminal 336, and the capacitive element 335 is disposed between the output terminal 332 and the ground terminal 336.

The signal generator 33 includes connecting wiring 76 in the conductive pattern 381. The winding portion 732 of the third portion 73 is electrically connected to one end of the connecting wiring 76 through a via Ha, and the winding portion 742 of the fourth portion 74 is electrically connected to the other end of the connecting wiring 76 through a via Hb. In other words, the winding portion 732 and the winding portion 742 are electrically connected via the connecting wiring 76.

As will be apparent from FIG. 8, when a current flows in a first direction al in the winding portion 731, a current also flows in the first direction α1 in the winding portion 732. When a current flows in the first direction α1 in the winding portion 731, a current flows in a second and opposite direction α2 in the winding portions 741 and 742. In other words, when the drive signal S is supplied to the detection coil 70, magnetic fields in opposite directions are generated respectively in the third portion 73 and the fourth portion 74, as illustrated in FIG. 9. A signal level of the drive signal S is periodically inverted. Therefore, the first direction α1 and the second direction α2 are periodically inverted while maintaining opposing directions.

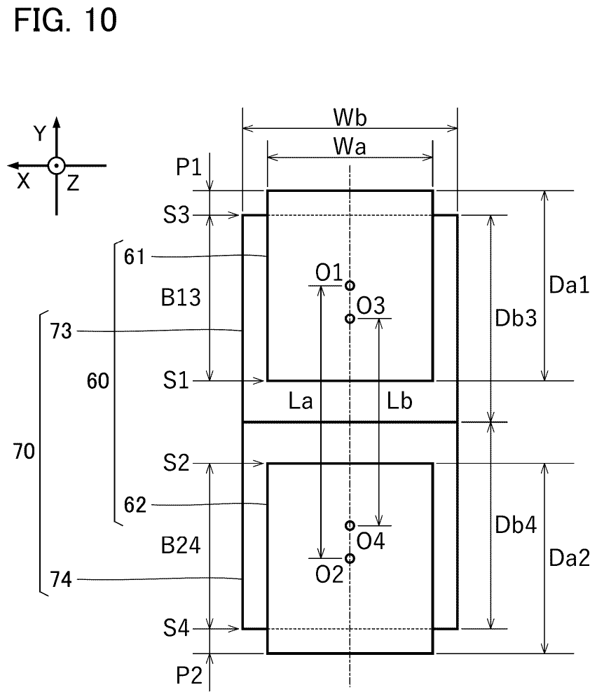

FIG. 10 is a schematic diagram of the dimensional and positional relation between the movable coil 60 and the detection coil 70. FIG. 10 illustrates the outline of the first portion 61 and the second portion 62 of the movable coil 60, and the outline of the third portion 73 and the fourth portion 74 of the detection coil 70. In FIG. 10, for convenience of illustration, the third portion 73 and the fourth portion 74 are illustrated adjoining each other. In an actual configuration, however, the third portion 73 and the fourth portion 74 are adjacent to each other with a space interposed therebetween, as illustrated in FIG. 8. However, the third portion 73 and the fourth portion 74 may adjoin each other with no space interposed therebetween, as illustrated in FIG. 10.

When the movable substrate 37 and the fixed substrate 38 are substantially parallel, the first portion 61 and the third portion 73 overlap each other in plan view, and the second portion 62 and the fourth portion 74 overlap each other in plan view, as illustrated in FIG. 10.

An outer dimension Da1 in FIG. 10 is the dimension of the first portion 61 in the direction of the Y-axis. Similarly, an outer dimension Da2 in FIG. 10 is the dimension of the second portion 62 in the direction of the Y-axis. Focusing on a closed figure defined by the outline of the first portion 61, the outer dimension Da1 of the first portion 61 is the dimension (size) of the closed figure in the direction of the Y-axis. In other words, the outer dimension Da1 is a maximum dimension of the first portion 61 in the direction of the Y-axis. The outline (closed figure) of the first portion 61 is the outermost periphery of the winding portion 611 or the winding portion 612. While the above description focuses on the first portion 61, the outer dimension Da2 of the second portion 62 is defined in the same way.

In the first embodiment, the outer dimension Da1 of the first portion 61 is equal to the outer dimension Da2 of the second portion 62. In the following description, the outer dimension Da1 and the outer dimension Da2 may be denoted as outer dimension Da (Da=Da1=Da2). The outer dimension Da1 is an example of a “first outer dimension,” and the outer dimension Da2 is an example of a “second outer dimension.”

An outer dimension Db3 in FIG. 10 is the dimension of the third portion 73 in the direction of the Y-axis. Similarly, an outer dimension Db4 in FIG. 10 is the dimension of the fourth portion 74 in the direction of the Y-axis. Focusing on the closed figure defined by the outline of the third portion 73, the outer dimension Db3 of the third portion 73 is the dimension (size) of the closed figure in the direction of the Y-axis. In other words, the outer dimension Db3 is the maximum dimension of the third portion 73 in the direction of the Y-axis. The outline (closed figure) of the third portion 73 is the outermost periphery of the winding portion 731 or of the winding portion 732. While the above description focuses on the third portion 73, the outer dimension Db4 of the fourth portion 74 is defined in the same way.

In the first embodiment, the outer dimension Db3 of the third portion 73 is equal to the outer dimension Db4 of the fourth portion 74. In the following description, the outer dimension Db3 and the outer dimension Db4 may be denoted as an outer dimension Db (Db=Db3=Db4). The outer dimension Db3 is an example of a “third outer dimension,” and the outer dimension Db4 is an example of a “fourth outer dimension.”

The outer dimension Da1 of the first portion 61 is equal to or smaller than the outer dimension Db3 of the third portion 73 (Da1≤Db3). In the first embodiment, the outer dimension Da1 is smaller than the outer dimension Db3 (Da1<Db3). The outer dimension Da1 is 0.5 times or more the outer dimension Db3 (0.5Db3≤Da1≤Db3).

Similarly, the outer dimension Da2 of the second portion 62 is equal to or smaller than the outer dimension Db4 of the fourth portion 74 (Da2≤Db4). In the first embodiment, the outer dimension Da2 is smaller than the outer dimension Db4 (Da2<Db4). The outer dimension Da2 is 0.5 times or more the outer dimension Db4 (0.5Db4≤Da2≤Db4).

In the first embodiment, the outer dimensions Da1 and Da2 are equal, and the outer dimensions Db3 and Db4 are equal as described above. Therefore, the outer dimension Da of each of the first portion 61 and the second portion 62 is equal to or smaller than the outer dimension Db of each of the third portion 73 and the fourth portion 74 (Da≤Db). Specifically, the outer dimension Da is smaller than the outer dimension Db (Da<Db). The outer dimension Da according to the first embodiment is 0.5 times or more the outer dimension Db (0.5 Db≤Da≤Db). The outer dimension Da may be equal to the outer dimension Db.

A center-to-center distance La in FIG. 10 is the distance between the center O1 of the first portion 61 and the center O2 of the second portion 62 in the direction of the Y-axis. The center O1 of the first portion 61 is the center (figure center) of the closed figure defined by the outline of the first portion 61. In the first embodiment, the via H1 corresponds to the center O1. Similarly, the via H2 in the second portion 62 corresponds to the center O2. The center-to-center distance La is an example of a “first distance.”

A center-to-center distance Lb in FIG. 10 is the distance between the center O3 of the third portion 73 and the center O4 of the fourth portion 74 in the direction of the Y-axis. The center O3 of the third portion 73 is the center (figure center) of the closed figure defined by the outline of the third portion 73. In the first embodiment, the via H3 is at the center O3. Similarly, the via H4 in the fourth portion 74 is at the center O4. The center-to-center distance Lb is an example of a “second distance.”

In the first embodiment, the center-to-center distance La between the first portion 61 and the second portion 62 is larger than the center-to-center distance Lb between the third portion 73 and the fourth portion 74 (La>Lb). The center-to-center distance La is twice or less the center-to-center distance Lb (Lb<La≤2 Lb).

The center O1 of the first portion 61, the center O2 of the second portion 62, the center O3 of the third portion 73, and the center O4 of the fourth portion 74 are each positioned on a line parallel to the Y-axis. The center O3 of the third portion 73 and the center O4 of the fourth portion 74 are each positioned between the center O1 of the first portion 61 and the center O2 of the second portion 62 in the direction of the Y-axis. Specifically, the center O3 is positioned between the center O1 and the center O4, and the center O4 is positioned between the center O2 and the center O3.

The center O1 of the first portion 61 and the center O3 of the third portion 73 are positioned within a range B13 where the first portion 61 and the third portion 73 overlap in plan view. FIG. 10 illustrates a side S1 of the first portion 61 positioned in the negative direction of the Y-axis and a side S3 of the third portion 73 positioned in the positive direction of the Y-axis. The range B13 is the range between the side S1 and the side S3. In other words, the center O1 and the center O3 are positioned between the side S1 and the side S3. If the center O1 or the center O3 is positioned on the side S1 or the side S3, it is considered to be “within the range B13.”

In plan view, the center O2 of the second portion 62 and the center O4 of the fourth portion 74 are positioned within a range B24 where the second portion 62 and the fourth portion 74 overlap. The range B24 is the range between a side S2 of the second portion 62 positioned in the positive direction of the Y-axis and a side S4 of the fourth portion 74 positioned in the negative direction of the Y-axis. In other words, the center O2 and the center O4 are positioned between the side S2 and the side S4. If the center O2 or the center O4 is positioned on the side S2 or the side S4, it is considered to be “within the range B24.”

As described above, the center-to-center distance La and the center-to-center distance Lb according to the first embodiment are set such that the center O1 and the center O3 are positioned within the range B13 and that the center O2 and the center O4 are positioned within the range B24. The configuration described above facilitates generation of an induced current in the first portion 61 due to the magnetic field generated in the third portion 73 as compared with a configuration in which one or both of the center O1 of the first portion 61 and the center O3 of the third portion 73 are positioned outside the range B13. Similarly, the configuration facilitates generation of an induced current in the second portion 62 due to the magnetic field generated in the fourth portion 74 as compared with a configuration in which one or both of the center O2 of the second portion 62 and the center O4 of the fourth portion 74 are positioned outside the range B24. Therefore, a detection signal D can be generated that reflects with high accuracy a distance between the movable coil 60 and the detection coil 70.

In plan view, a portion P1 of the first portion 61 opposing the second portion 62 is positioned outside the third portion 73. In other words, the portion P1 is a portion of the first portion 61 positioned in the positive direction of the Y-axis with respect to the side S3 of the third portion 73. Thus, the portion P1 of the first portion 61 protrudes from the side S3 in the positive direction of the Y-axis, i.e., the portion P1 of the first portion 61 that is away from the second portion 62 protrudes beyond the third portion 73. As described above, in plan view the first portion 61 according to the first embodiment partially overlaps the third portion 73.

In plan view, a portion P2 of the second portion 62 opposing the first portion 61 is positioned outside the fourth portion 74. In other words, the portion P2 is a portion of the second portion 62 positioned in the negative direction of the Y-axis with respect to the side S4 of the fourth portion 74. Thus, the portion P2 of the second portion 62 protrudes from the side S4 in the negative direction of the Y-axis, i.e., the portion P2 of the second portion 62 that is away from the first portion 61 protrudes beyond the fourth portion 74. As described above, in plan view the second portion 62 according to the first embodiment partially overlaps the fourth portion 74.

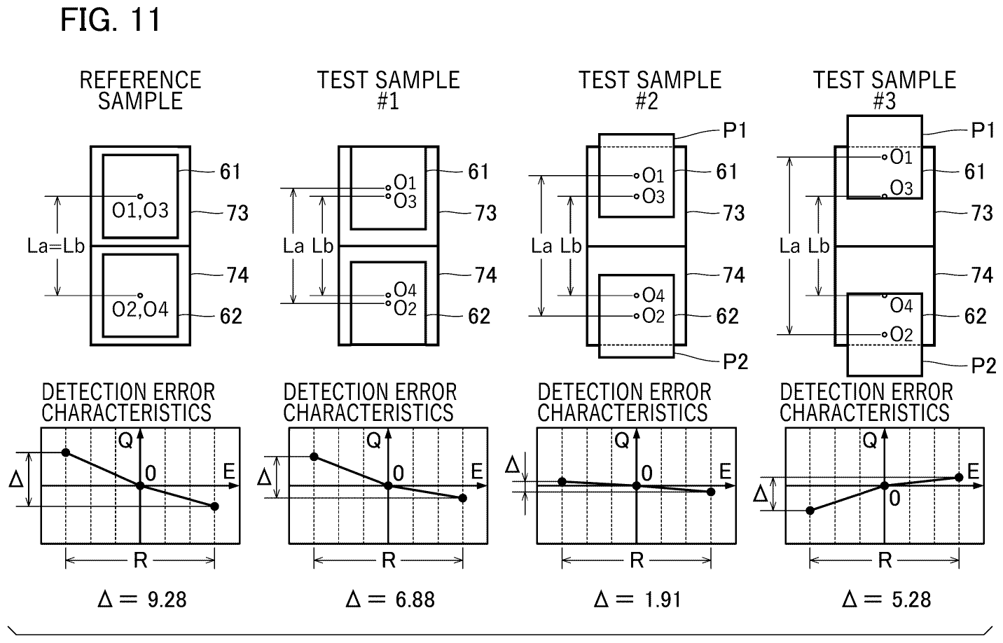

FIG. 11 illustrates results of evaluation of detection characteristics of the detection system 30 for each of a plurality of test samples with varying center-to-center distances La. In FIG. 11, detection error characteristics are illustrated for each of the test samples.

The detection error characteristics refer to relations between a position error E (horizontal axis) and a measurement speed Q (vertical axis). A position error E is an error between the positions of the movable coil 60 and the detection coil 70 in the direction of the Y-axis. When the movable coil 60 is at a target designed position with respect to the detection coil 70 in the direction of the Y-axis, the position error E is 0. When the movable coil 60 is misaligned in a negative direction of the Y-axis with respect to the target position, the position error E is expressed as a negative number. When the movable coil 60 is misaligned in the positive direction of the Y-axis with respect to the target position, the position error E is expressed as a positive number.

The measurement speed Q is a speed of the movable coil 60 as specified by analysis of the detection signal D generated by the detection system 30 when the movable coil 60 is moved at a predetermined speed. The measurement speed Q is normalized such that the measurement speed Q is 0 when the position error E is 0.

In FIG. 11, the amount of speed fluctuation A is illustrated in the detection error characteristics. The amount of speed fluctuation Δ is the absolute value of the difference between the maximum value and the minimum value of the measurement speed Q within a range R of the values assumed for the position error E. In other words, the amount of speed fluctuation Δ is an index that indicates, when there is an error in position (position error E) between the movable coil 60 and the detection coil 70, how the measurement speed Q specified by the detection signal D changes relative to the error. The range R is an allowable range of the position error E.

In other words, when an amount of speed fluctuation Δ is large, the measurement speed Q fluctuates significantly even if there is only a slight error between the positions of the movable coil 60 and the detection coil 70. Thus, when the amount of speed fluctuation Δ is small, an error in the measurement speed Q can be suppressed when there is an error between the positions of the movable coil 60 and the detection coil 70. As will be understood from the above description, it is necessary to reduce the amount of speed fluctuation Δ to a small value to prevent or reduce degradation in detection accuracy due to an error between the positions of the movable coil 60 and the detection coil 70.

A reference sample in FIG. 11 is a sample where the center O1 of the first portion 61 and the center O3 of the third portion 73 are located at the same position, and the center O2 of the second portion 62 and the center O4 of the fourth portion 74 are located at the same position. In other words, the center-to-center distance La is equal to the center-to-center distance Lb in the reference sample.

Test samples #1 to #3 are samples where the center-to-center distance La between the first portion 61 and the second portion 62 is gradually increased from that in the reference sample, with the center-to-center distance Lb between the third portion 73 and the fourth portion 74 remaining unchanged.

As illustrated in FIG. 11, the amount of speed fluctuation Δ for each of the samples from the test sample #1 to the test sample #3 is smaller than the amount of speed fluctuation Δ in the reference sample. Accordingly, it can be evaluated that the amount of speed fluctuation Δ is reduced by a configuration where the center-to-center distance La is larger than the center-to-center distance Lb illustrated in FIG. 10. In other words, it is possible to prevent or reduce degradation in detection accuracy due to an error between the positions of the movable coil 60 and the detection coil 70 in the direction of the Y-axis.

The test sample #1 is a case where the entire first portion 61 overlaps the third portion 73, and the entire second portion 62 overlaps the fourth portion 74. The test sample #2 and the test sample #3 are cases where the first portion 61 includes the portion P1 positioned outside the third portion 73, and the second portion 62 includes the portion P2 positioned outside the fourth portion 74. The amount of speed fluctuation Δ for each of the test sample #2 and the test sample #3 is smaller than the amount of speed fluctuation Δ in the reference sample or the test sample #1. Therefore, it can be evaluated that the configuration in which the first portion 61 includes the portion P1 and the configuration in which the second portion 62 includes the portion P2 reduce the amount of speed fluctuation Δ. In other words, the first embodiment can prevent or reduce degradation in detection accuracy due to an error in the positions of the movable coil 60 and the detection coil 70 in the direction of the Y-axis.

As illustrated in FIG. 10, a dimension (i.e., width) Wb of the detection coil 70 in the direction of the X-axis is larger than a dimension Wa of the movable coil 60 in the direction of the X-axis (Wb>Wa). With the configuration described above, the area where the movable coil 60 and the detection coil 70 overlap does not change even if an error (horizontal misalignment) occurs between the positions of the movable coil 60 and the detection coil 70 in the direction of the X-axis. Accordingly, the configuration can prevent or reduce the occurrence of an error in the output characteristics of the detection signal D due to an error between the positions of the movable coil 60 and the detection coil 70 in the direction of the X-axis. Consequently, it is possible to prevent or reduce degradation in detection accuracy due to an error between the positions of the movable coil 60 and the detection coil 70 in the direction of the X-axis.

### B: Second Embodiment

A second embodiment of the present disclosure is described below. In the following aspects, elements having the same functions as those according to the first embodiment are denoted by the same reference numerals as those in the description of the first embodiment, and detailed description thereof is omitted as appropriate.

The second embodiment focuses on a center-to-center distance ratio C. The center-to-center distance ratio C is a dimensionless quantity expressed by the following Expression (1):

$$C = ( La - Lb ) / Db \qquad ( 1 )$$

As will be understood from Expression (1), the center-to-center distance ratio C is a value obtained by dividing, by the outer dimension Db3 of the third portion 73 or the outer dimension Db4 of the fourth portion 74 in the direction of the Y-axis, the difference (La−Lb) between the distance La, which is a distance between the center O1 of the first portion 61 and the center O2 of the second portion 62, and the distance Lb, which is a distance between the center O3 of the third portion 73 and the center O4 of the fourth portion 74. In other words, the center-to-center distance ratio C is the ratio of the difference (La−Lb) between the center-to-center distance La and the center-to-center distance Lb, relative to the outer dimension Db of the third portion 73 or the fourth portion 74.

The distance between the center O1 of the first portion 61 and the center O3 of the third portion 73 and the distance between the center O2 of the second portion 62 and the center O4 of the fourth portion 74 are each expressed as (La−Lb)/2. Therefore, the center-to-center distance ratio C is a value obtained by dividing the distance (La−Lb)/2 between the center O1 (O2) and the center O3 (O4) by a half Db/2 of the outer dimension Db ({(La−Lb)/2}/{Db/2}).

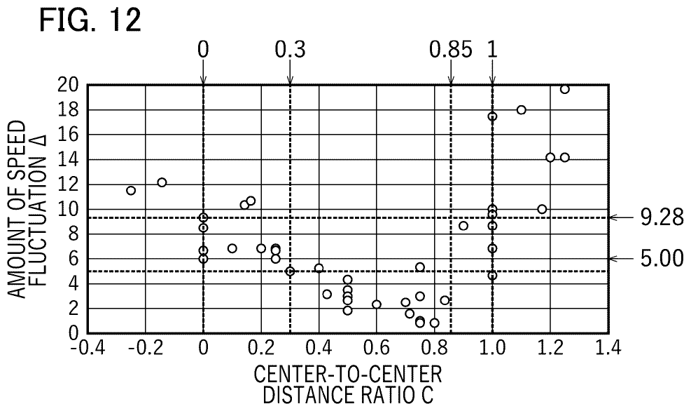

FIG. 12 illustrates the results of evaluation of the detection characteristics of the detection system 30 for each of a plurality of test samples with varying center-to-center distance ratios C. Specifically, FIG. 12 illustrates the relation between the center-to-center distance ratio C (horizontal axis) and the amount of speed fluctuation Δ (vertical axis) for the test samples. The test samples according to the second embodiment include not only samples where the dimensional and positional relation between the movable coil 60 and the detection coil 70 satisfies the conditions according to the first embodiment but also samples that do not satisfy the conditions.

As will be apparent from FIG. 12, there is a correlation between the center-to-center distance ratio C and the amount of speed fluctuation Δ. Specifically, the amount of speed fluctuation Δ decreases as the center-to-center distance ratio C increases from 0 and increases in turn as the center-to-center distance ratio C increases from a predetermined value (e.g., a value of around 0.6). Thus, there is a general tendency that the amount of speed fluctuation Δ reaches the minimum value (local minimum value) when the center-to-center distance ratio C is a value of around 0.6.

Focus is now on a reference sample serving as a reference for an amount of speed fluctuation Δ. Similarly to the first embodiment, the reference sample is a sample for which the center O1 of the first portion 61 and the center O3 of the third portion 73 are located at the same position, and the center O2 of the second portion 62 and the center O4 of the fourth portion 74 are located at the same position. In other words, the center-to-center distance La is equal to the center-to-center distance Lb in the reference sample. The amount of speed fluctuation Δ of the reference sample is 9.28.

As will be understood from FIG. 12, the range of the center-to-center distance ratio C where the amount of speed fluctuation Δ is smaller than the value of the reference sample (Δ=9.28) is 0 or more than 0, up to and including 1. Based on the results of the examination described above, in the second embodiment, the dimensions and the positions of the elements of the movable coil 60 and the detection coil 70 are determined such that the center-to-center distance ratio C is 0 or more than 0 up to and including 1 (0≤C≤1). The configuration where the center-to-center distance ratio C is 0 or larger than 0 is a configuration where the center-to-center distance La between the first portion 61 and the second portion 62 is equal to or larger than the center-to-center distance Lb between the third portion 73 and the fourth portion 74 (La≥Lb). The configuration where the center-to-center distance ratio C is 1 or smaller than 1 is a configuration where the difference (La−Lb) between the center-to-center distance La and the center-to-center distance Lb is equal to or smaller than the outer dimension Db of the third portion 73 or the fourth portion 74.

In the second embodiment, the dimensions and the positions of the elements of the movable coil 60 and the detection coil 70 are determined such that the center-to-center distance ratio C is larger than 0 and smaller than 1 (0<C<1). In other words, the center-to-center distance La is larger than the center-to-center distance Lb, and the difference (La−Lb) between the center-to-center distances La and Lb is smaller than the outer dimension Db.

The amount of speed fluctuation Δ according to the second embodiment is smaller than that in the reference sample because the center-to-center distance ratio C satisfies the conditions described above. Accordingly, the second embodiment can prevent or reduce degradation in detection accuracy due to an error in the positions of the movable coil 60 and the detection coil 70 in the direction of the Y-axis compared with the reference sample.

While comparison with reference samples has been provided in the above description, in an actual product, an amount of speed fluctuation Δ is preferably a value of 5 or less. As will be apparent from FIG. 12, the range of the center-to-center distance ratio C where the amount of speed fluctuation Δ is equal to or smaller than 5 is equal to or larger than 0.3 and equal to or smaller than 0.85. Based on the results described above, in the second embodiment, the dimensions and the positions of the elements of the movable coil 60 and the detection coil 70 are determined such that the center-to-center distance ratio C is equal to or larger than 0.3 and equal to or smaller than 0.85 (0.3≤C≤0.85). More specifically, the dimensions and the positions of the elements of the movable coil 60 and the detection coil 70 are determined such that the center-to-center distance ratio C is larger than 0.3 and smaller than 0.85 (0.3<C<0.85).

The amount of speed fluctuation Δ according to the second embodiment is reduced to a value of 5 or less because the center-to-center distance ratio C satisfies the conditions described above. Therefore, the second embodiment can adequately prevent or reduce degradation in detection accuracy due to an error between the positions of the movable coil 60 and the detection coil 70 in the direction of the Y-axis.

The relation between the first embodiment and the second embodiment is further described below. In the first embodiment, the dimensions and the positions of the elements of the movable coil 60 and the detection coil 70 are determined such that the following first conditions are satisfied.

### First Conditions

1A: The outer dimension Da1 of the first portion 61 in the direction of the Y-axis is equal to or smaller than the outer dimension Db3 of the third portion 73 in the direction of the Y-axis; and the outer dimension Da2 of the second portion 62 in the direction of the Y-axis is equal to or smaller than the outer dimension Db4 of the fourth portion 74 in the direction of the Y-axis.
1B: The center-to-center distance La between the center O1 of the first portion 61 and the center O2 of the second portion 62 is larger than the center-to-center distance Lb between the center O3 of the third portion 73 and the center O4 of the fourth portion 74.
1C: The center O3 of the third portion 73 and the center O4 of the fourth portion 74 are positioned between the center O1 of the first portion 61 and the center O2 of the second portion 62 in the direction of the Y-axis.

On the other hand, in the second embodiment, the dimensions and the positions of the elements of the movable coil 60 and the detection coil 70 are determined such that the following second conditions are satisfied.

### Second Conditions

The center-to-center distance ratio C is 0 or larger than 0 up to and including 1, where the center-to-center distance ratio C is a value obtained by dividing the difference (La-Lb) between the center-to-center distance La between the first portion 61 and the second portion 62 and the center-to-center distance Lb between the third portion 73 and the fourth portion 74 by the outer dimension Db (Db3, Db4) of the third portion 73 or the fourth portion 74 in the direction of Y-axis.

The movable coil 60 and the detection coil 70 may satisfy both the first and the second conditions or only one of the first and the second conditions. In other words, for example, in the second embodiment, the first conditions need not necessarily be satisfied. Specifically, the outer dimension Da according to the second embodiment may be larger than the outer dimension Db (the condition 1A is not satisfied).

### C: Modifications

Following are examples of modifications that can be made to the embodiments described above. Two or more modes optionally selected from the modes described below may be appropriately combined as long as they do not contradict each other.
(1) The detection system 30 detects the displacement of the hammer mechanism 22 in the embodiments described above. However, an object to be detected by the detection system 30 is not limited to the hammer mechanism 22. Examples are given below.

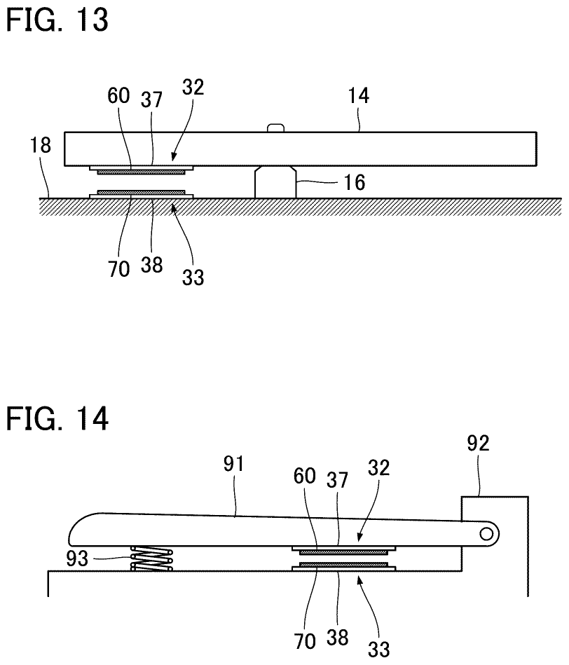

FIG. 13 is a schematic diagram focusing on one key 14 of the keyboard musical instrument 100. As illustrated in FIG. 13, the detectable part 32 is disposed on the key 14. The movable coil 60 is disposed on the lower surface of the key 14, for example. The signal generator 33 including the detection coil 70 is disposed on the support structure 18. The movable coil 60 and the detection coil 70 face each other.

FIG. 14 is a schematic illustrating a pedal mechanism 90 of the keyboard musical instrument 100. The pedal mechanism 90 includes a pedal 91 operated by the user's foot, a support member 92 that supports the pedal 91, and an elastic member 93 that biases the pedal 91 vertically upward. In the configuration described above, the detectable part 32 is disposed on the pedal 91. More specifically, the movable coil 60 is disposed on the lower surface of the pedal 91. The signal generator 33 including the detection coil 70 is disposed on the support member 92. The movable coil 60 and the detection coil 70 face each other.

It is of note that while the pedal mechanism 90 of the keyboard musical instrument 100 is illustrated in FIG. 14, a configuration substantially similar to that in FIG. 14 can be employed for pedal mechanisms used with electric musical instruments, such as electric stringed musical instruments (e.g., electric guitars). A pedal mechanism used with electric musical instruments is, for example, an effects pedal that is operated by the user to adjust various sound effects, such as distortion or compression.

Furthermore, the keyboard musical instrument 100 is given as an example in the embodiments described above. However, the present disclosure may be applied to an object other than the example described above. A configuration substantially similar to those according to the embodiments described above can be employed to detect a position of an operative element operated by the user when the user plays a wind instrument, such as a woodwind instrument (e.g., a clarinet or a saxophone) or a brass instrument (e.g., a trumpet or a trombone).

As will be understood from the examples described above, the elements provided with the movable coil 60 are represented as a movable member configured to be displaced responsive to a playing operation. The movable member includes not only an instrument operative element, such as the key 14 or the pedal 91, which is directly operated by the user but also a structure, such as the hammer mechanism 22, which is displaced in concurrence with an operation performed on the instrument operative element. The movable member according to the present disclosure, however, is not limited to a member configured to be displaced responsive to a playing operation. In other words, the movable member is a member that can be displaced regardless of a cause of displacement.

An error in position in the direction of the Y-axis may occur between the positions of the movable coil 60 and the detection coil 70 for a variety of reasons, such as an assembly error in the keyboard musical instrument 100. If an error occurs between the positions of the movable coil 60 and the detection coil 70 in the direction of the Y-axis, an error in output characteristics may become apparent. The present disclosure can prevent or reduce degradation in detection accuracy due to an error between the positions of the movable coil 60 and the detection coil 70 in the direction of the Y-axis because the present disclosure can reduce an amount of speed fluctuation Δ as described above.

In a configuration where an angle between the movable coil 60 and the detection coil 70 changes as the movable coil 60 is displaced, an error in the output characteristics due to an error between the positions of the movable coil 60 and the detection coil 70 is particularly likely to become apparent. In other words, in the configuration where the angle between the movable coil 60 and the detection coil 70 changes, the amount of speed fluctuation Δ in the detection error characteristic tends to be larger. Since the present disclosure reduces an amount of speed fluctuation Δ as described above, the present disclosure is particularly suitable for a configuration in which the movable coil 60 is provided within the hammer mechanism 22 that pivots responsive to the playing operation, i.e., in which the detection system 30 is used to detect the position of the hammer mechanism 22.
(2) In the second embodiment, the combination of the lower limit (0, 0.3) and the upper limit (0.85, 1) that defines the range of the center-to-center distance ratio C may be changed as appropriate. For example, the center-to-center distance ratio C may be 0 or larger than 0 up to and including 0.85, or a value of 0.3 or larger than 0.3 up to an including 1.
(3) Magnetic fields are respectively generated in opposite directions in the first portion 61 and the second portion 62 of the movable coil 60 in the embodiments described above. However, magnetic fields may be respectively generated in the same direction in the first portion 61 and the second portion 62. In other words, currents may respectively flow in the same direction in the first portion 61 and the second portion 62.

Magnetic fields in opposite directions are respectively generated in the third portion 73 and the fourth portion 74 of the detection coil 70 in the embodiments described above. However, magnetic fields may be respectively generated in the same direction in the third portion 73 and the fourth portion 74. In other words, currents may respectively flow in the same direction in the third portion 73 and the fourth portion 74.
(4) While the movable coil 60 is configured of a layer each of the conductive pattern 371 and the conductive pattern 372 in the embodiments described above, the configuration of the movable coil 60 is not limited to the example described above. For example, the movable coil 60 may be configured of a single layer or of three or more layers. Similarly, the detection coil 70 may be configured of a single layer or three or more layers.
(5) The planar shape of the first portion 61 and the second portion 62 of the movable coil 60 and the third portion 73 and the fourth portion 74 of the detection coil 70 is rectangular in the embodiments described above. However, the planar shape of the movable coil 60 and the detection coil 70 is not limited to that of the embodiments described above.

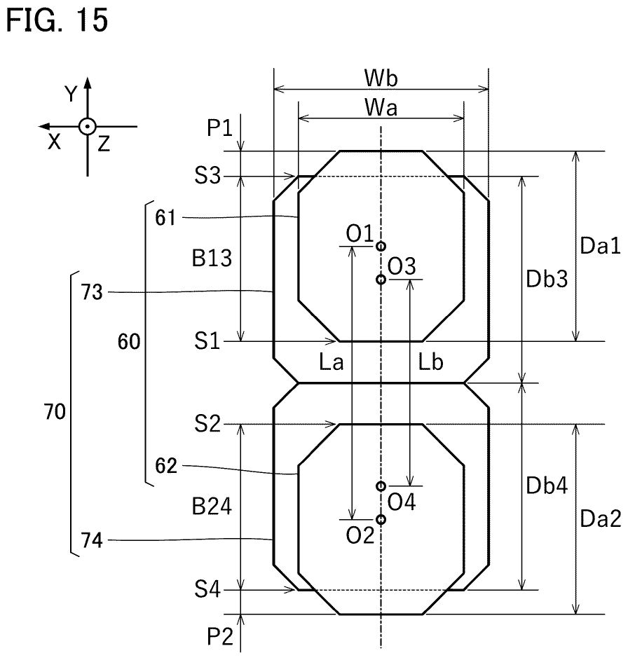

For example, as illustrated in FIG. 15, the planar shape of the first portion 61 and the second portion 62 of the movable coil 60 may be a polygon (e.g., an octagon) other than a rectangle. Similarly, the planar shape of the third portion 73 and the fourth portion 74 of the detection coil 70 may be a polygon (e.g., an octagon) other than a rectangle.

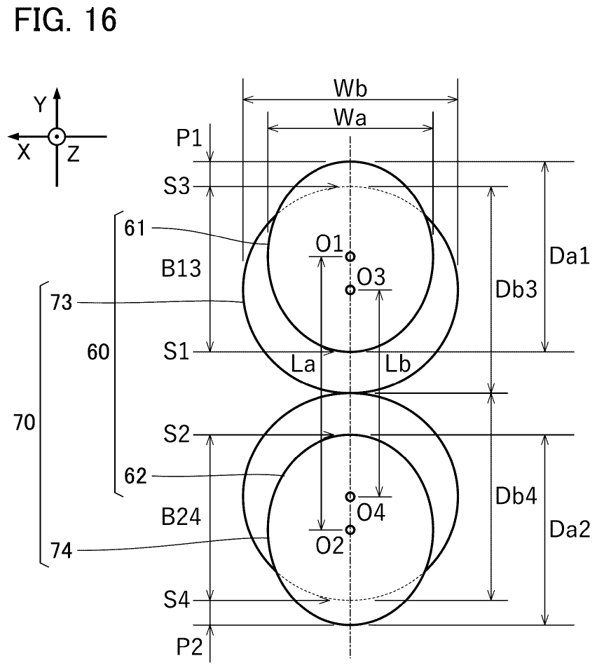

As illustrated in FIG. 16, the planar shape of the first portion 61 and the second portion 62 of the movable coil 60 may be a circle (e.g., a perfect circle, an oval, or an ellipse). Similarly, the planar shape of the third portion 73 and the fourth portion 74 of the detection coil 70 may be a circle (e.g., a perfect circle, an oval, or an ellipse).

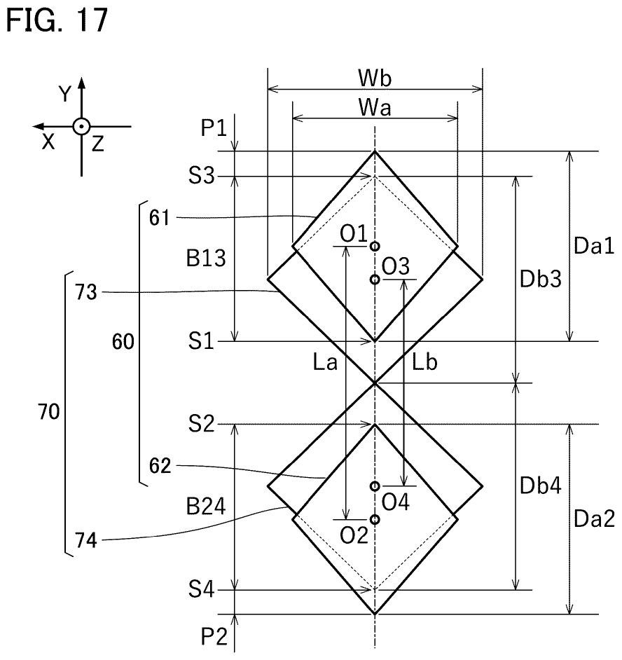

As illustrated in FIG. 17, the planar shape of the first portion 61 and the second portion 62 of the movable coil 60 may be a polygon with a diagonal along the Y-axis. Similarly, the planar shape of the third portion 73 and the fourth portion 74 of the detection coil 70 may be a polygon with a diagonal along the Y-axis.

As will be apparent from the examples set out in FIGS. 15 to 17, the dimensions of each part of the movable coil 60 and the detection coil 70 satisfy the conditions according to the embodiments described above regardless of the planar shape of the movable coil 60 and the detection coil 70.

For example, the outer dimension Da1 is the dimension of the first portion 61 in the direction of the Y-axis, and the outer dimension Da2 is the dimension of the second portion 62 in the direction of the Y-axis regardless of the planar shape of the movable coil 60. Similarly, the outer dimension Db3 is the dimension of the third portion 73 in the direction of the Y-axis, and the outer dimension Db4 is the dimension of the fourth portion 74 in the direction of the Y-axis regardless of the planar shape of the detection coil 70. The relation between the outer dimension Da (Da1, Da2) and the outer dimension Db (Db3, Db4) is the same as that in the embodiments described above.

The center-to-center distance La is the distance between the center O1 of the first portion 61 and the center O2 of the second portion 62 in the direction of the Y-axis regardless of the planar shape of the movable coil 60. Similarly, the center-to-center distance Lb is the distance between the center O3 of the third portion 73 and the center O4 of the fourth portion 74 in the direction of the Y-axis regardless of the planar shape of the detection coil 70. The relation between the center-to-center distance La and the center-to-center distance Lb is the same as that in the embodiments described above. The preferable range of the center-to-center distance ratio C is the same as that in the second embodiment.

In plan view, the portion P1 of the first portion 61 opposing the second portion 62 is positioned outside the third portion 73, regardless of the planar shape of the movable coil 60 and the detection coil 70. Similarly, in plan view, the portion P2 of the second portion 62 opposing the first portion 61 is positioned outside the fourth portion 74 regardless of the planar shape of the movable coil 60 and the detection coil 70.
(6) The outer dimension Da1 of the first portion 61 is equal to the outer dimension Da2 of the second portion 62 (Da1=Da2=Da) in the embodiments described above. However, the outer dimension Da1 need not be the same as the outer dimension Da2. Specifically, the outer dimension Da1 may be larger than the outer dimension Da2, or the outer dimension Da2 may be larger than the outer dimension Da1.

Similarly, the outer dimension Db3 of the third portion 73 is equal to the outer dimension Db4 of the fourth portion 74 (Db3=Db4=Db) in the embodiments described above. However, the outer dimension Db3 may be different from the outer dimension Db4. Specifically, the outer dimension Db3 may be larger than the outer dimension Db4, or the outer dimension Db4 may be larger than the outer dimension Db3.

In a mode where the outer dimension Da1 is different from the outer dimension Da2, the relation between the outer dimensions Da1 and Db4 and the relation between the outer dimensions Da2 and Db3 are not particularly limited. In other words, the outer dimension Da1 may be equal to or larger than the outer dimension Db4, and the outer dimension Da2 may be equal to or larger than the outer dimension Db3. Similarly, in a mode where the outer dimension Db3 is different from the outer dimension Db4, the relation between the outer dimensions Da1 and Db4 and the relation between the outer dimensions Da2 and Db3 are not particularly limited.
(7) An electric musical instrument in which the sound source device 44 generates the audio signal V is given as an example in the embodiments described above. However, the embodiments described above are also applicable to acoustic keyboard musical instruments (keyboard musical instruments of natural musical instruments) in which a sound source, such as a string, generates a musical sound, for example. In such acoustic keyboard musical instruments, the weight 222 described in the above embodiments is replaced by a hammer that strikes a string. The embodiments described above are also applicable to keyboard musical instruments that include a mechanism that causes strings to be struck, such as an automatic player piano or a silent piano. In the keyboard musical instrument described above, the detection system 30 is used to detect displacement of a movable member, such as the key 14 or the hammer mechanism 22 (or a hammer). The “musical instrument” according to the present disclosure is an instrument used to play music, and both electric and acoustic musical instruments are included within the definition of “musical instrument.”
(8) A drive mechanism 20 of an upright piano is given as an example in the embodiments described above. However, the embodiments described above are also applicable to keyboard musical instruments including a drive mechanism for a grand piano. The type of the keyboard musical instrument to which the present disclosure is applied is not limited to pianos. For example, the embodiments described above are also applicable to various keyboard musical instruments, such as celestas or glockenspiels.
(9) The term “n-th” (n is a natural number) in the present application is used only as a formal and convenient denotation (label) to distinguish elements in the description and has no intrinsic meaning. Therefore, the usage precludes any restrictive interpretation of a position or order of manufacture of an element described as a “n-th.”

### D: Appendix

The following aspects, for example, are derivable from the embodiments described above.

### Aspect A

A detection system according to an aspect (aspect A1) of the present disclosure includes a displaceable first coil and a second coil configured to receive a drive signal and to generate a magnetic field based on the received drive signal, the detection system being configured to generate a detection signal dependent on a distance between the displaceable first coil and the second coil, in which the displaceable first coil includes a first portion and a second portion that are disposed along a first axis, the second coil includes a third portion facing the first portion and a fourth portion facing the second portion, a first outer dimension of the first portion in a direction of the first axis is equal to or smaller than a third outer dimension of the third portion in the direction of the first axis, a second outer dimension of the second portion in the direction of the first axis is equal to or smaller than a fourth outer dimension of the fourth portion in the direction of the first axis, a first distance between the center of the first portion and the center of the second portion is larger than a second distance between the center of the third portion and the center of the fourth portion, and the center of the third portion and the center of the fourth portion are positioned between the center of the first portion and the center of the second portion in the direction of the first axis.

If an error (vertical misalignment) occurs between the positions of the first coil and the second coil in the direction of the first axis, the aspect described above prevents or reduces an occurrence of an error in the output characteristics of the detection signal (e.g., the relation between the distance between the first coil and the second coil and the signal level of the detection signal) due to the error. In other words, the aspect can prevent or reduce degradation in detection accuracy due to an error in the positions between the first coil and the second coil in the direction of the first axis.

The state where the first portion and the third portion “face each other” means a state where the central axis of the first portion and the third portion pass through the other. In other words, the state where the first portion and the third portion “face each other” is a state where a plane orthogonal to the central axis of the first portion faces a plane orthogonal to the central axis of the third portion, and typically is a state where the central axis of the first portion is parallel to the central axis of the third portion.

The first portion and the third portion need not necessarily face each other when the first coil is at a certain position within a movable range. If the first portion and the third portion face each other when the first coil is at a specific position within the movable range, the first portion and the third portion are considered to “face each other.” One of the first portion and the third portion need not necessarily entirely face the other and may only partially face the other. While the explanation above focuses on the first portion and the third portion, the same principles apply to the relation between the second portion and the fourth portion.

When focusing on a closed figure (external shape) defined by the outline of the first portion, the “outer dimension” of the first portion in the direction of the first axis is the dimension (size) of the closed figure in the direction of the first axis. In other words, the outer dimension is the maximum value of the dimension of the first portion in the direction of the first axis. The “center” of the first portion means the center (figure center) of the closed figure defined by the outline of the first portion. While the explanation above focuses on the first portion, the same principles apply to the second to the fourth portions.

In a specific example (aspect A2) of the aspect A1, the first outer dimension is smaller than the third outer dimension, and the second outer dimension is smaller than the fourth outer dimension. The aspect described above has a significant effect in preventing or reducing degradation in detection accuracy due to an error between the positions of the first coil and the second coil in the direction of the first axis.

In a specific example of the aspect A1 or A2, the first outer dimension and the second outer dimension are equal to each other, and the third outer dimension and the fourth outer dimension also are equal to each other. According to the aspects described above, the planar shape of the first coil and the second coil can be simplified.

In a specific example (aspect A4) of any one of the aspect A1 to the aspect A3, in a plan view, the center of the first portion and the center of the third portion are within a range where the first portion and the third portion overlap with each other; and in the plan view, the center of the second portion and the center of the fourth portion are within a range where the second portion and the fourth portion overlap with each other. The aspect described above facilitates generation of an induced current in the first portion due to the magnetic field generated in the third portion as compared with a configuration in which one or both of the centers of the first portion and the third portion are outside the range where the first portion and the third portion overlap with each other. Similarly, the aspect described above facilitates generation of an induced current in the second portion due to the magnetic field generated in the fourth portion compared with a configuration in which one or both of the centers of the second portion and the fourth portion are outside the range where the second portion and the fourth portion overlap with each other. Therefore, a detection signal can be generated that reflects with high accuracy a distance between the first coil and the second coil.

The phrase “within the range” where the first portion and the third portion overlap encompasses not only the area inside the range but also includes the periphery (outline) of the range. Therefore, an aspect where the center of the first portion or the center of the third portion is on the line of the range where the first portion and the third portion overlap also satisfies the requirement of “within the range.” The same applies to a range where the second portion and the fourth portion overlap.

In a specific example (aspect A5) according to any one of aspect A1 to the aspect A4, in a plan view, a portion of a first portion that is away from the second portion protrudes beyond the third portion; and in the plan view a portion of the second portion that is away from the first portion protrudes beyond the fourth portion. The aspect described above prevents or reduces degradation in detection accuracy due to an error between the positions of the first coil and the second coil in the direction of the first axis as compared to a configuration where in the plan view the entire first portion is positioned inside the third portion; or with a configuration in the plan view where the entire second portion is positioned inside the fourth portion.

In the aspects described above, it is easier to secure an area of the first portion and the second portion as compared with the configuration in plan view in which the entire first portion is positioned inside the third portion; and the configuration in plan view in which the entire second portion is positioned inside the fourth portion. Therefore, a detection signal can be generated that reflects with high accuracy a distance between the first coil and the second coil.

In a specific example (aspect A6) according to any one of the aspect A1 to the aspect A5, the dimension of the second coil in a direction of a second axis orthogonal to the first axis is larger than the dimension of the displaceable first coil in the direction of the second axis. If an error (horizontal misalignment) occurs between the positions of the first coil and the second coil in the direction of the second axis, the aspect described above prevents or reduces an occurrence of an error in the output characteristics of the detection signal due to the error.

In other words, the aspect prevents or reduces degradation in detection accuracy due to an error between the positions of the first coil and the second coil in the direction of the second axis.

In a specific example (aspect A7) according to any one of the aspect A1 to the aspect A6, Lb<La≤2 Lb, where “La” represents the first distance, and “Lb” represents the second distance (i.e., the first distance is larger than and twice or less the second distance). The aspect described above effectively prevents or reduces degradation in detection accuracy due to an error between the positions of the first coil and the second coil in the direction of the second axis because the first distance is smaller than twice the second distance. More preferably, the first distance is 1.4 times to 1.6 times the second distance.

In a specific example (aspect A8) according to any one of the aspect A1 to the aspect A7, 0.5Db3≤Da1≤Db3, where “Da1” represents the first outer dimension, and “Db3” represents the third outer dimension (i.e., the first outer dimension is 0.5 times or more and equal to or smaller than the third outer dimension), and 0.5Db4≤Da2≤Db4, where “Da2” represents the second outer dimension, and “Db4” represents the fourth outer dimension (i.e., the second outer dimension is 0.5 times or more and equal to or smaller than the fourth outer dimension). In the aspect described above, the area of the first portion and the second portion is adequately secured. Therefore, a detection signal can be generated that reflects with high accuracy the distance between the first coil and the second coil.

In a specific example (aspect A9) according to any one of the aspect A1 to the aspect A8, a center-to-center distance ratio (La−Lb)/Db is 0 or larger than 0 up to and including 1, where the center-to-center distance ratio (La−Lb)/Db is a value obtained by dividing a difference (La−Lb) between a distance La and a distance Lb by an outer dimension Db of the third portion or the fourth portion in the direction of the first axis, where the distance La is a distance between the center of the first portion and the center of the second portion, and wherein the distance Lb is a distance between the center of the third portion and the center of the fourth portion. In a specific example (aspect A10) of the aspect A9, the center-to-center distance ratio (La−Lb)/Db is 0.3 or larger up to and including 0.85.

In a specific example (aspect A11) according to any one of the aspect A1 to the aspect A10, the displaceable first coil is disposed within a movable member that is displaceable responsive to a playing operation. In a more specific example (aspect A12), the movable member is a hammer mechanism that is pivotable responsive to the playing operation. In a configuration where an angle between the first coil and the second coil changes as the first coil is displaced, an error in the output characteristics due to an error between the positions of the first coil and the second coil is likely to become apparent. Considering the tendency described above, the present disclosure is particularly suitable for a configuration in which the first coil is provided within the hammer mechanism that is caused to rotate responsive to the playing operation, that is, in which the detection system is used to detect the position of the hammer mechanism.

A musical instrument according to an aspect (aspect A13) of the present embodiment includes a movable member that is displaceable responsive to a playing operation and a detection system, in which the detection system includes a first coil disposed on the movable member and a second coil configured to receive a drive signal and to generate a magnetic field based on the received drive signal, the detection system is configured to generate a detection signal dependent on a distance between the first coil and the second coil, the first coil includes a first portion and a second portion that are disposed along a first axis, the second coil includes a third portion facing the first portion and a fourth portion facing the second portion, a first outer dimension of the first portion in a direction of the first axis is equal to or smaller than a third outer dimension of the third portion in the direction of the first axis, a second outer dimension of the second portion in the direction of the first axis is equal to or smaller than a fourth outer dimension of the fourth portion in the direction of the first axis, a first distance between the center of the first portion and the center of the second portion is larger than a second distance between the center of the third portion and the center of the fourth portion, and the center of the third portion and the center of the fourth portion are positioned between the center of the first portion and the center of the second portion in the direction of the first axis.

In a specific example (aspect A14) according to the aspect A13, a center-to-center distance ratio (La−Lb)/Db is 0 or larger than 0 up to and including 1, where the center-to-center distance ratio (La−Lb)/Db is a value obtained by dividing a difference (La−Lb) between a distance La and a distance, by an outer dimension Db of the third portion or the fourth portion in the direction of the first axis, in which the distance La is a distance between the center of the first portion and the center of the second portion, and wherein the distance Lb is a distance between the center of the third portion and the center of the fourth portion.

### Aspect B

A detection system according to an aspect (aspect B1) of the present disclosure includes a first coil that is displaceable and a second coil configured to generate a magnetic field upon supply of a drive signal, the detection system being configured to generate a detection signal dependent on a distance between the first coil and the second coil, in which the first coil includes a first portion and a second portion aligned along a first axis, the second coil includes a third portion facing the first portion and a fourth portion facing the second portion, and a center-to-center distance ratio (La−Lb)/Db is 0 or larger than 0 up to and including 1, where the center-to-center distance ratio (La−Lb)/Db is a value obtained by dividing a difference (La−Lb) between a distance La and a distance Lb by an outer dimension Db of the third portion or the fourth portion in the direction of the first axis, in which the distance La is a distance between the center of the first portion and the center of the second portion and the distance Lb is a distance between the center of the third portion and the center of the fourth portion. In a specific example (aspect B2) of the aspect B1, the center-to-center distance ratio (La−Lb)/Db is larger than 0 and smaller than 1.

Even if an error (vertical misalignment) occurs between the positions of the first coil and the second coil in the direction of the first axis, the aspect described above prevents or reduces occurrence of an error in the output characteristics of the detection signal (e.g., the relation of the distance between the first coil and the second coil and the signal level of the detection signal) due to the error. In other words, the aspect prevents or reduces degradation in detection accuracy due to an error between the positions of the first coil and the second coil in the direction of the first axis.

In a specific example (aspect B3) of the aspect B1, the center-to-center distance ratio (La−Lb)/Db is 0.3 or larger up to and including 0.85. In a more specific example, the center-to-center distance ratio (La−Lb)/Db is larger than 0.3 and smaller than 0.85. Even if an error (vertical misalignment) occurs between the positions of the first coil and the second coil in the direction of the first axis, the aspect described above prevents or reduces an occurrence of an error in the output characteristics of the detection signal (e.g., the relation between the distance between the first coil and the second coil and the signal level of the detection signal) due to the error. In other words, the aspect prevents or reduces degradation in detection accuracy due to an error between the positions of the first coil and the second coil in the direction of the first axis.

In a specific example (aspect B5) according to any one of the aspect B1 to the aspect B4, the first coil is provided within a hammer mechanism that rotates responsive to a playing operation. In a configuration where an angle between the first coil and the second coil changes as the first coil is displaced, an error in the output characteristics due to an error in the positions of the first coil and the second coil is likely to become apparent. Considering the tendency described above, the present disclosure is particularly suitable for a configuration in which the first coil is provided within the hammer mechanism that is caused to pivot responsive to the playing operation, that is, in which the detection system is used to detect the position of the hammer mechanism.

A musical instrument according to an aspect (aspect B6) of the present disclosure includes a movable member configured to be displaced responsive to a playing operation and a detection system, in which the detection system includes a first coil within the movable member and a second coil configured to generate a magnetic field upon supply of a drive signal, the detection system is configured to generate a detection signal dependent on a distance between the first coil and the second coil, the first coil includes a first portion and a second portion aligned along a first axis, the second coil includes a third portion facing the first portion and a fourth portion facing the second portion, a first outer dimension of the first portion in a direction of the first axis is equal to or smaller than a third outer dimension of the third portion in the direction of the first axis, a second outer dimension of the second portion in the direction of the first axis is equal to or smaller than a fourth outer dimension of the fourth portion in the direction of the first axis, and a center-to-center distance ratio (La−Lb)/Db is 0 or larger up to an including 1, where the center-to-center distance ratio (La−Lb)/Db is a value obtained by dividing a difference (La−Lb) between a distance La and a distance Lb, by an outer dimension Db of the third portion or the fourth portion in the direction of the first axis, in which the distance La is a distance between the center of the first portion and the center of the second portion, and wherein the distance Lb is a distance between the center of the third portion and the center of the fourth portion.

### DESCRIPTION OF REFERENCE SIGNS

100 keyboard musical instrument
10 keyboard unit
12 keyboard
14 key
18 support structure
20 drive mechanism
21 transmission mechanism
22 hammer mechanism
221 hammer shank
222 weight
223 holding member
30 detection system
31 magnetic sensor
32 detectable part
33 signal generator
35 drive circuit
37 movable substrate
38 fixed substrate
40 control system
41 control device
42 storage device
43 A/D converter
44 sound source device
50 sound output system
60 movable coil
61 first portion
62 second portion
70 detection coil
73 third portion
74 fourth portion
76 connecting wiring
90 pedal mechanism
91 pedal
92 support member
93 elastic member
321 capacitive element
331 input terminal
332 output terminal
333 resistive element
334, 335 capacitive element
351 supply circuit
352 output circuit
371, 372, 381, 382 conductive pattern
611, 612, 621, 622, 731, 732, 741, 742 winding portion

1. A detection system comprising:
a displaceable first coil; and
a second coil configured to receive a drive signal and to generate a magnetic field based on the received drive signal,
the detection system being configured to generate a detection signal dependent on a distance between the displaceable first coil and the second coil,
wherein:
the displaceable first coil includes a first portion and a second portion that are disposed along a first axis,
the second coil includes a third portion facing the first portion and a fourth portion facing the second portion,
a first outer dimension of the first portion in a direction of the first axis is equal to or smaller than a third outer dimension of the third portion in the direction of the first axis,
a second outer dimension of the second portion in the direction of the first axis is equal to or smaller than a fourth outer dimension of the fourth portion in the direction of the first axis,
a first distance between a center of the first portion and a center of the second portion is larger than a second distance between a center of the third portion and a center of the fourth portion, and
the center of the third portion and the center of the fourth portion are positioned between the center of the first portion and the center of the second portion in the direction of the first axis.

2. The detection system according to claim 1, wherein:
the first outer dimension is smaller than the third outer dimension, and
the second outer dimension is smaller than the fourth outer dimension.

3. The detection system according to claim 2, wherein:
the first outer dimension and the second outer dimension are equal to each other, and
the third outer dimension and the fourth outer dimension are equal to each other.

4. The detection system according to claim 1, wherein:
in a plan view, the center of the first portion and the center of the third portion are positioned within a range where the first portion and the third portion overlap with each other, and
in the plan view, the center of the second portion and the center of the fourth portion are positioned within a range where the second portion and the fourth portion overlap with each other.

5. The detection system according to claim 1, wherein:
in a plan view, a portion of the first portion that is away from the second portion protrudes beyond the third portion, and
in the plan view, a portion of the second portion that is away from the first portion protrudes beyond the fourth portion.

6. The detection system according to claim 1, wherein a dimension of the second coil in a direction of a second axis orthogonal to the first axis is larger than a dimension of the displaceable first coil in the direction of the second axis.

7. The detection system according to claim 1, wherein Lb<La≤2Lb, where “La” represents the first distance, and “Lb” represents the second distance.

8. The detection system according to claim 1, wherein:
0.5Db3≤Da1≤Db3, where “Da1” represents the first outer dimension, and “Db3” represents the third outer dimension, and
0.5Db4≤Da2≤Db4, where “Da2” represents the second outer dimension, and “Db4” represents the fourth outer dimension.

9. The detection system according to claim 1, wherein a center-to-center distance ratio (La−Lb)/Db is 0 or larger than 0 up to and including 1, where the center-to-center distance ratio (La−Lb)/Db is a value obtained by dividing a difference (La−Lb) between a distance La and a distance Lb, by an outer dimension Db of the third portion or the fourth portion in the direction of the first axis, wherein the distance La is a distance between the center of the first portion and the center of the second portion, and wherein the distance Lb is a distance between the center of the third portion and the center of the fourth portion.

10. The detection system according to claim 9, wherein the center-to-center distance ratio (La−Lb)/Db is 0.3 or larger than 0.3 up to and including 0.85.

11. The detection system according to claim 1, wherein the displaceable first coil is disposed within a movable member that is displaceable responsive to a playing operation.

12. The detection system according to claim 11, wherein the movable member is a hammer mechanism that is pivotable responsive to the playing operation.

13. A musical instrument comprising:
a movable member that is displaceable responsive to a playing operation; and
a detection system including:
a first coil disposed on the movable member; and
a second coil configured to receive a drive signal and to generate a magnetic field based on the received drive signal,
wherein:
the detection system is configured to generate a detection signal dependent on a distance between the first coil and the second coil,
the first coil includes a first portion and a second portion that are disposed along a first axis,
the second coil includes a third portion facing the first portion and a fourth portion facing the second portion,
a first outer dimension of the first portion in a direction of the first axis is equal to or smaller than a third outer dimension of the third portion in the direction of the first axis,
a second outer dimension of the second portion in the direction of the first axis is equal to or smaller than a fourth outer dimension of the fourth portion in the direction of the first axis,
a first distance between a center of the first portion and a center of the second portion is larger than a second distance between a center of the third portion and a center of the fourth portion, and
the center of the third portion and the center of the fourth portion are positioned between the center of the first portion and the center of the second portion in the direction of the first axis.

14. The musical instrument according to claim 13, wherein a center-to-center distance ratio (La−Lb)/Db is 0 or larger than 0 up to and including 1, where the center-to-center distance ratio (La−Lb)/Db is a value obtained by dividing a difference (La−Lb) between a distance La and a distance Lb, by an outer dimension Db of the third portion or the fourth portion in the direction of the first axis, wherein the distance La is a distance between the center of the first portion and the center of the second portion, and wherein the distance Lb is a distance between the center of the third portion and the center of the fourth portion.
